(19) United States
(12) Patent Application Publication
(10) Pub. No.: US 2012/0323760 A1
(43) Pub. Date: Dec. 20, 2012

(54) DYNAMIC LOAN SERVICE MONITORING SYSTEM AND METHOD

(75) Inventors: Haengju Lee, Webster, NY (US); Shanmuga-Nathan Gnanasambandam, Victor, NY (US); Rajinderjeet Singh Minhas, Rochester, NY (US); Shi Zhao, Rochester, NY (US); Andres Quiroz Hernandez, Rochester, NY (US); Gary Morey, Canandaigua, NY (US); David Cacciola, (US); William Voll, Hilton, NY (US)

(73) Assignee: XEROX CORPORATION, Norwalk, CT (US)

(21) Appl. No.: 13/162,364

(22) Filed: Jun. 16, 2011

(51) Int. Cl. G06Q 40/02

(52) U.S. Cl. 705/38

(57) ABSTRACT

The disclosure describes a method and system monitoring a set of loans and identifying loans in the set that that are likely to default before an upcoming date. The system uses a set of data about loans that are in a default status and loans that are in a non-default status to train a set of loan models. The loan models include at least one model for a defaulted loan and at least one model for a non-defaulted loan. After the loan models are created, the system monitors active loans and classifies each active loan in accordance with one of the loan models. Based on the loan model to which the active loan is classified, the processor will determine a probability of default over a prospective time period for the active loan and issue an alert when a loan's probability of default exceeds a threshold.

### BACKGROUND

This document describes a method and system that monitors data relating to a set of loans and predicts the probability that an active loan will enter a status of default within a period of time.

When a financial institution loans money to consumers, the financial institution will typically monitor the status of each loan to determine which loans are current, delinquent, in default, or in other states. While understanding current status information is important, mere status information does not allow the lender to efficiently detect which loans are likely to enter a default status. Loan analysts can view status information over time and guess that a borrower may default if the loan has been delinquent for a period of time. However, the manual monitoring required to make such assessments is extremely labor-intensive. In addition, accuracy of the results will vary based on the judgment of the loan analyst. Further, because of the manual labor required, the response time needed to proactively address risky loans is extremely long.

This document describes a method and system directed to resolving some or all of the problems described above.

### SUMMARY

In an embodiment, a loan monitoring system includes a processor and a computer-readable storage medium. The storage medium is a tangible device that holds programming instructions that instruct the processor to implement a method that receives a loan data set. The loan data set includes a first set of data relating to a set of loans that are in a default status and second set of data relating to loans that are in a non-default status. The processor develops, based on the first data and the second data, a set of loan models, wherein the loan models comprise at least one defaulted loan model and at least one non-defaulted loan model. The processor then receives data relating to a target loan. Based on the data relating to the target loan, the processor will classify the target loan in accordance with one of the loan models. Based on the loan model to which the target loan is classified, the processor will determine a probability of default over a prospective time period for the target loan.

In various embodiments, the processor may also deliver a message to a loan service provider. The message may identify the probability of default, or it may include a report reflecting the probability of default.

The processor also may determine whether the probability of default exceeds a threshold. If the processor determines that the probability of default exceeds the threshold, it may initiate delivery of an alarm message to a loan service provider, where the alarm message includes information such as the probability of default.

When the processor develops the set of loan models, in various embodiments it may select a number of loan models from the set of loan models, and then train each of the loan models. Training a model may include: (i) analyzing, for each loan in the loan data set, observed data over a historic time period; (ii) determining a number of hidden states for the model, wherein the number of hidden states is that which minimizes a Bayesian information criterion; and (iii) for at least one hidden state in the model, establishing a probability that any loan in the loan data set will move from that state to another hidden state in the model during the historic time period. The hidden states may include a first state in which a majority of loans are paid off, a second state in which a majority of loans are current, a third state in which a majority of loans are delinquent, and a fourth state in which a majority of loans are in default, forbearance, deferment or subject to a claim. Other states, as well as subsets of each of these states, are possible.

When the processor classifies the target loan in accordance with one of the loan models, in various embodiments it may determine a posterior probability that the target loan would have corresponded to each of the loan models during a historic time period, and then classify the target loan in accordance with the loan model having the highest determined posterior probability.

When the processor determines a probability of default within a prospective time period for the target loan, in various embodiments for the loan model to which the target loan is classified the processor may: (i) identify the hidden state that represents a state of default; (ii) establish a probability that the target loan will be in the state of default in a prospective time period, and (iii) select the established probability as the probability of default.

### BRIEF DESCRIPTION OF THE DRAWINGS

FIG. 1 illustrates an exemplary Hidden Markov Model (HMM) representation of a coin toss scenario.

FIG. 2 illustrates an exemplary HMM representation of an alternate coin toss scenario.

FIG. 3 is a flowchart illustrating various steps of a process for monitoring an active loan and determining whether the loan is likely to default.

FIGS. 4-8 show exemplary HMM representations of various loan models.

FIG. 9 is a graph showing an exemplary loan's probability of default as it changes over time.

FIG. 10 illustrates various embodiments of a computing device for implementing various methods and processes described herein.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

As used in this document, a statement that a device or system is “in electronic communication with” another device or system means that devices or systems are configured to send data, commands and/or queries to each other via a communications network. The network may be a wired or wireless network such as a local area network, a wide area network, an intranet, the Internet or another network.

As used in this document, the phrase “target loan” means an active loan that is monitored using methods and systems such as those described in this document.

This document describes a system that automates the loan monitoring process and helps a loan service provider reduce the response time in dealing with defaulted loans. The disclosed embodiments apply a model, such as the Hidden Markov Model (HMM), to historic loan data to analyze each borrower's historical payment patterns and predict each borrower's probability of defaulting in the near future. The system may generate an alert for a system user (such as a loan service department) when the predicted probability of defaulting is greater than a predetermined threshold. The monitoring system is dynamic in a sense that any loan's probability of default may change as new information about the loan is added to the historical data.

The models illustrate that the health of a borrower's financial state can be partially implied in the borrower's loan status (current, delinquent, forbearance, etc.) and the number of days during which a loan's payment status is not current. The borrower's payment behavior may illustrate a hidden financial state of the borrower. If the borrower's financial state is healthy, the borrower typically makes his or her payments on schedule in time. However, one or more late payments may be an indicator of hidden financial problems.

The modeling uses time series data of each borrower's behavior. In addition, the sequence in which on-time payments and late payments occur is also used to reveal the borrower's financial state. This means that a sequence [current at time 1, current at time 2, and delinquent at time 3] should be treated differently from the sequence [delinquent at time 1, current at time 2, and current at time 3] even though there are two current states and one delinquent state in both sequences. This is because the probability of defaulting at a future time [time 4] of the first sequence may be different from that of the second sequence.

To determine hidden states, the system may analyze the data in the framework of a Hidden Markov Model (HMM), or with another model such as a Kalman filter model or a finite state machine. The system trains a set of HMMs, including at least one representing a paid loan (“paid HMM”) and at least one that represents a defaulted loan (“defaulted HMM”). Instead of using a single defaulted HMM, the system may segment stages of default and develop an HMM for each state, such as “default for 1 month—no claim made”, or “default for three months—claim filed”, as well as lesser default stages such as forbearance or sustained delinquency.

In 2008, there was a known attempt to analyze loan service data using HMMs. (See Aldrich et al., “Using pattern recognition to analyze Prosper.com,” published by the Massachusetts Institute of Technology.) In this work, the researchers analyzed the loan performance data of Prosper.com to predict loan defaults. However, the research did not provide for any ability to determine a predicted default time, nor did it provide the ability to predict whether a default may occur within a particular time period. In contrast, the inventors for this document have developed a method and system that predicts default in a certain time period (typically a point in the near future) and signals to a loan service when a high probability of default may be near.

The embodiments described in this document also may use the Bayesian Information Criterion (BIC) to select an optimal number of hidden financial states for each model. When an active loan is analyzed for potential default, the system will classify the loan to the HMM with the greatest posterior probability and calculate the default probability in a prospective time period (such as a next month).

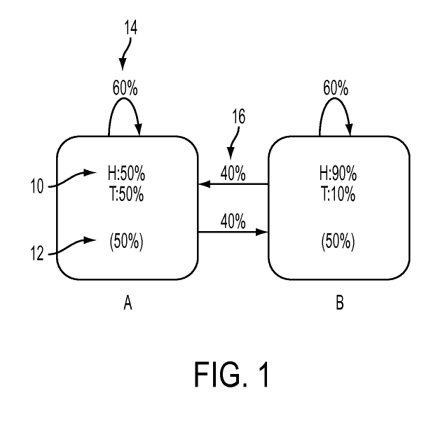

As background for the embodiments described in this document, it is helpful to provide some background on the HMM concept. FIG. 1 illustrates a simple example of how one may model a coin toss with an HMM representation. When a coin is tossed, the outcome may be either heads (H) or tails (T). A single flip of a fair, or typical, coin will have a 50/50 probability 10 of yielding a heads or tails result, illustrated as state A in FIG. 1. However a biased coin may have an uneven probability, such as 90% heads probability and a 10% tails probability (state B). If the two coins were sitting together on a table, then the probability that a user will start with a particular coin 12 is 50% of for each coin. If a person were to pick up a coin and toss it, the person may have a 60% probability of staying in the same state 14 (i.e., using the same coin on the next toss) and a 40% probability of moving to from state A to state B (or vice versa) 16.

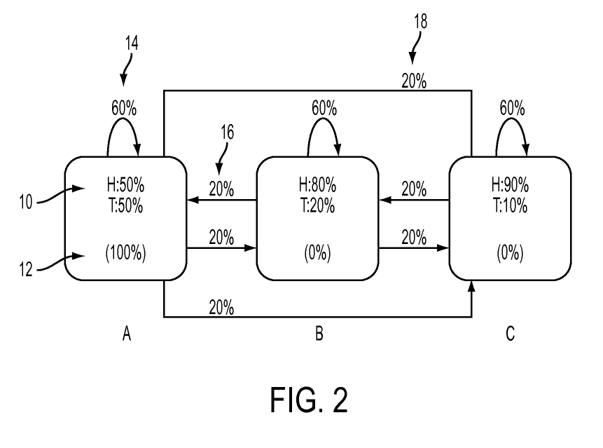

FIG. 2 illustrates an HMM representation of a situation where three coins are available. One coin is fair, and the other two coins are biased. In this model, a person will always start by tossing the fair one (as shown by the initial 100% probability of state A). The person would then have a 60% probability of staying in the same state 14 (i.e., using the same coin on the next toss), a 20% probability of moving from state A to state B 16 (i.e., moving to one of the biased coins on the next toss), and a 20% probability of moving from state A to state C 18 (i.e., moving to the other biased coin on the next toss). Other probabilities of moving between (or staying in) states A, B and C on subsequent tosses are shown in FIG. 2.

The HMM representations shown in FIGS. 1 and 2 uses three parameter sets for a given number of hidden states (where each “state” represents a possible coin to toss):

1. Initial state distribution (i.e., which coin will be initially tossed);

2. Probability that the state will change from one state to any other state; and

3. Observation probabilities for each hidden state (i.e., probability of a heads or a tails result for each coin).

With this framework, in the context of loan analysis the embodiments disclosed in this document may consider a number of possible hidden financial states of the borrower. A borrower's financial state may be difficult to observe, but we know that the financial states can change over time. For example, the borrower's financial state can become healthier when she is promoted or gets a new job with higher salary. Likewise, the borrower's financial state can go in the other direction after a job loss. The systems described in this document observe the borrower's payment behavior as evidenced by the borrower's loan data (e.g., whether payments are made on time) and use those observations to predict the borrower's future financial state.

A borrower's current financial state with respect to a loan may be categorized in any number of possible ways for use in a model. In one embodiment, possible states may include:
Paid off (i.e., no further payments due);
Current (i.e., all payments due to date are paid);
Delinquent (i.e., the latest payment is past due);
Deferment (i.e., payment obligations are postponed without interest due to external factors such as military service or school enrollment);
Forbearance (i.e., payment obligations are postponed for a short period of time); or
In default.

Any of these states may stand on their own, or they may be segmented into multiple states. For example, instead of a single delinquent state the model may consider various stages of delinquency, such as one month past due, two months past due, three months past due, and so on. Similarly, instead of a single default state the model may include states where the loan is eligible for a claim to be filed, where the loan is subject to a filed claim, and states where the claim has been rejected or granted. Alternatively, the states listed above may be combined. For example, deferment and forbearance may be considered subsets of the current, delinquent or default state.

When the states are identified, they may be assigned various codes. For example, a set of codes for 37 possible states may include:

| Code | Meaning |
|---|---|
| 1 | Grace period |
| 2 | Current |
| 3 | 1 month delinquent |
| 5 | 2 months delinquent |
| 6 | 3 or more months delinquent |
| 7 | Deferment |
| 8 | Forbearance |
| 9 | Default - claim eligible |
| [. . .] | |
| 35 | Default, claim filed |
| 36 | Default, claim completed |
| 37 | Paid in full |

With this structure, the system may build the model for a loan data set. The model may generate loan observation sequences that include the status codes of a loan over a period of time. For example, a 6-month sequence for a loan may be [3, 5, 2, 2, 3, 37], which means that the loan was in delinquent in the first, second and fifth months, current in the third and fourth months, and paid off in the sixth month. The following parameters may be used to characterize the model:
1) N: the number of hidden financial states. How to determine the optimal number of states for our model will be explained.
   qₜ: the state at time t. qₜ: ε {1, 2, 3, . . . , N}
2) M: the number of distinct symbols per state. In this example, the number of distinct status codes generated per state is 37.
   vₜ: the status code at time t. vₜ: ε {1, 2, 3, . . . , 37}
3) The Initial state distribution.
   πᵢ=Pr (q₁=i), 1≦i≦N.
4) The state transition probability distribution.
   A 32 {aᵢⱼ}, where aᵢⱼ=Pr(qₜ₊₁=j|qₜ=i), 1≦i, j≦N.
5) The observation symbol probability distribution per state.
   B={bⱼ(k)}, where bⱼ(k)=Pr(vₜ=k|qₜ=j), 1≦k≦37 and 1≦j≦N.

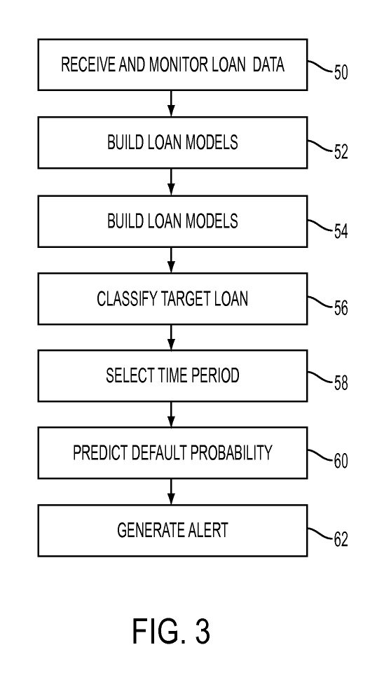

Referring to FIG. 3, the system may implement a method that will receive and monitor a loan data set 50 such as that listed above over a period of time. The loan data may be received into the system by manual input, automatic transfer from a loan service, or any other suitable means and stored in a database. In a typical system, some of the loans will be in a default status and some of the loans will be in a non-default status. The system may analyze this loan data and develop a set of loan models 52 using methods such as those described below using computer-readable instructions. The system will use two or more loan models, four or more loan models, or any number of loan models. Then, the system may monitor data 54 for any active loan of interest—referred to in this document as a target loan or active loan—and analyze the data to classify 56 the target loan in accordance with one of the models.

The system may then select a future time period of interest 58, such as one month, two months, three months, or another period. The selection may be made automatically according to a default, randomly, or in response to a user selection or other command. The system will then predict 60, or determine a probability, whether the target loan will move into a default state within the prospective time period of interest. The system may repeat this for multiple loans and generate an alert 62 as to loans that are likely to move into a default state during the time period of interest. The alert may be delivered to a user by any suitable method, such as by transmitting a message to a loan service provider, or by printing or displaying data indicating the loans that are predicted to default.

### Model Development

The system may use any of various methods to monitor the loan data and build the models. Three suitable methods (a naïve Method, a simple HMM method, and a segmented HMM method) are described below. The system may determine the optimal number of hidden states for the model using a Bayesian Information Criterion (BIC) or other suitable criteria.

Simple HMM Method:

In a simple HMM Method, two models are “trained”, or developed based on analysis of loan data for numerous loans, such as 1,000 loans or more, 5,000 loans or more, 10,000 loans or more, or 100,000 loans or more. The two models are: a paid HMM, and a defaulted HMM. The paid HMM is trained with observations of loans that have been paid in full, while the defaulted HMM is trained with defaulted observations.

To train the model, the processor may run the Baum-Welch algorithm to estimate parameters of the HMM for the various number of hidden states.

In the case of the paid HMM, the last hidden state of N represents the absorbing paid state, so there is no outgoing state transition from the paid state. Note that parameters set to be zero initially remain zero in all the recursive parameter updates in the Baum-Welch algorithm. Using this, we can let the state N be the paid state by assigning the following initial parameters at the start of the Baum-Welch algorithm:

a_{Nj}=0 for ∀j≠N and a_{NN}=1.

b_{N}(k)=0 for ∀k≠36 and b_{N}(36)=1.

We also set the last hidden state of N to be the defaulted absorbing state in the case of the defaulted HMM. This can be done by assigning the following initial parameters in the Baum-Welch algorithm:

a_{Nj}=0 for ∀j≠N and a_{NN}=1.

b_{N}(k)=0 for ∀k≠35 and b_{N}(35)=1.

To choose an optimal number of hidden states for the model, the system may use a BIC as the model selection criterion. We define BIC_{N} as the BIC for which the number of hidden states is N, and the system determines the N that minimizes BIC. The selected N which minimizes BIC is the optimal number of hidden states. BIC may be represented by the following formula:

$${BIC}_{N} = - ln L ( {O}_{N} ) + \frac{{d}_{N}}{2} ln \vert data \vert ,$$

where L(0_{N}) is the maximum-likelihood when the number of hidden states is N. d_{N} is the number of parameters and |data| is the number of observation data.

Minimizing BIC is equivalent to maximizing −BIC, which considers a maximum of the log-likelihood and a penalty term (d/2 ln |data|). Because of the penalty term, when two models have same log-likelihood, BIC favors a smaller model with fewer parameters. The number of parameters (d_{N}) is the sum of parameters for initial probabilities, state transition probabilities, and observation probabilities per state. The initial probabilities may be defined for each state. However, when the other (N−1) probabilities are determined, the remaining probability may be automatically determined so that the sum of all the probabilities would be one (i.e., 100%).

With similar reasoning for the other two probability distributions, we can derive the equation for d_{N}:

d_{N}=(N−1)+N(N−1)+N(37−1).

As an example, the system may analyze a loan data set and calculate BICs for the paid HMM while varying the number of hidden states. An exemplary result summary is shown in Table 1 below. In Table 1, when the number of states is 3, the number of parameters (d_{N}) is 116, and the negative of the log-likelihood is 129,664.64. Therefore, BIC is 129,664.64+0.5*116*ln(13,771)=130,217.13. The minimum BIC is achieved when the number of states is 10.

TABLE 1

| | # of | | −Log- | |
|---|---|---|---|---|
| Paid | parameters | | likelihood | |
| Model (N) | (d_{N}) | penalty | (−ln L) | BIC_{N} |
| 3 states | 116 | 552.76 | 129,664.64 | 130,217.40 |
| 4 states | 159 | 757.66 | 122,039.03 | 122,796.69 |
| 5 states | 204 | 972.09 | 119,204.98 | 120,177.07 |
| 6 states | 251 | 1,196.06 | 114,528.06 | 115,724.11 |
| 7 states | 300 | 1,429.55 | 114,595.21 | 116,024.76 |
| 8 states | 351 | 1,672.57 | 111,387.54 | 113,060.11 |
| 9 states | 404 | 1,925.12 | 112,264.30 | 114,189.42 |
| 10 states | 459 | 2,187.21 | 109,278.25 | 111,465.46 |
| 11 states | 516 | 2,458.82 | 112,176.85 | 114,635.67 |
| 12 states | 575 | 2,739.97 | 112,163.02 | 114,902.99 |

In a similar way, the system may train a defaulted HMM by analyzing a loan data set using a BIC analysis of the defaulted HMM as shown in Table 2 below. The optimal number of hidden states is 8 for this case.

TABLE 2

| | # of | | −Log- | |
|---|---|---|---|---|
| Default | parameters | | likelihood | |
| Model (N) | (d_{N}) | penalty | (−ln L) | BIC_{N} |
| 3 states | 116 | 527.85 | 147,128.61 | 147,656.46 |
| 4 states | 159 | 723.52 | 131,225.89 | 131,949.41 |
| 5 states | 204 | 928.29 | 115,051.47 | 115,979.75 |
| 6 states | 251 | 1,142.16 | 100,459.50 | 101,601.66 |
| 7 states | 300 | 1,365.13 | 86,087.14 | 87,452.27 |
| 8 states | 351 | 1,597.20 | 75,756.37 | 77,353.57 |
| 9 states | 404 | 1,838.37 | 88,144.93 | 89,983.31 |
| 10 states | 459 | 2,088.65 | 85,514.78 | 87,603.42 |
| 11 states | 516 | 2,348.02 | 83,955.83 | 86,303.86 |
| 12 states | 575 | 2,616.50 | 80,359.33 | 82,975.82 |

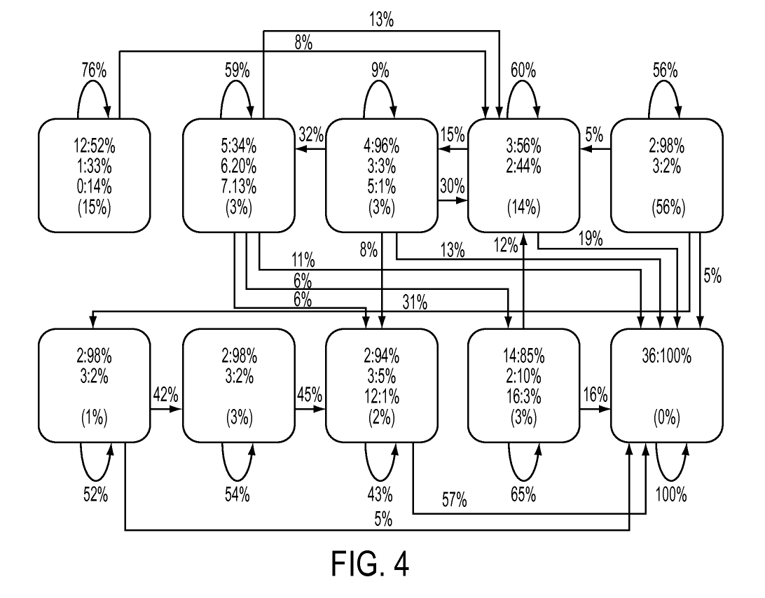

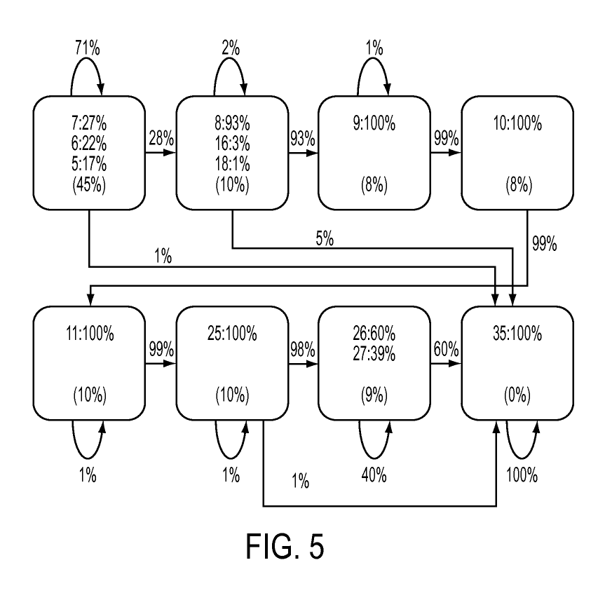

The processor may run the Baum-Welch algorithm for the paid HMM with the optimal number of hidden states for each model. The final trained result for the exemplary ten-state paid HMM is depicted in FIG. 4, and that for the eight-state defaulted HMM is depicted in FIG. 5. Each square in FIG. 4 and FIG. 5 represents a different possible hidden state, and three most prevalent observations for each hidden state are shown in each square in the format “status code: probability”. The arrows illustrate the possible state transitions with percentages representing the probability of each state-to-state transition.

Segmented HMM Method:

In a segmented HMM method, the system investigates a status code distribution of defaulted loans over a historic or posterior time period (such as a previous month just before defaulting) to identify states when a default is likely to occur in a future or prospective time period (such as the next month). An exemplary distribution for a loan data set is summarized in Table 3, which shows that 38 loans with a prior status code 2 (current) defaulted in the month following current status. Therefore, the distribution is widely distributed with two peaks at each of status codes 26 and 27. In this example, about 94% of the defaulted loans are in status 26 or 27:

TABLE 3

| Status code | Count | |
|---|---|---|
| 1 | 2 | (0.01%) |
| 2 | 38 | (0.42%) |
| 3 | 24 | (0.27%) |
| 4 | 17 | (0.19%) |
| 5 | 8 | (0.09%) |
| 6 | 12 | (0.13%) |
| 7 | 5 | (0.06%) |
| 8 | 2 | (0.02%) |
| 9 | 3 | (0.03%) |
| 10 | 6 | (0.07%) |
| 11 | 7 | (0.08%) |
| 12 | 9 | (0.10%) |
| 14 | 10 | (0.11%) |
| 15 | 1 | (0.01%) |
| 16 | 130 | (1.45%) |
| 17 | 20 | (0.22%) |
| 18 | 24 | (0.27%) |
| 19 | 15 | (0.17%) |
| 20 | 23 | (0.26%) |
| 21 | 13 | (0.15%) |
| 22 | 18 | (0.20%) |
| 23 | 10 | (0.11%) |
| 24 | 4 | (0.04%) |
| 25 | 98 | (1.09%) |
| 26 | 2,918 | (32.56%) |
| 27 | 5,526 | (61.65%) |
| 28 | 4 | (0.04%) |
| 29 | 2 | (0.02%) |
| 30 | 5 | (0.06%) |
| 34 | 3 | (0.03%) |
| 32 | 1 | (0.01%) |
| 33 | 3 | (0.03%) |
| 34 | 2 | (0.02%) |

The system may continue model development by investigating the two most likely status codes (26, 27). Analyzing the loan data set, the system determines that if a loan is in the status code of 27, it has a 99.41% probability of defaulting in the next month as shown below in Table 4. If a loan is in the status code of 26, it has a 34.08% probability of defaulting in the next month and a 64.92% probability of moving to status 27 as shown in Table 5.

TABLE 4

| Status code | Count | |
|---|---|---|
| 2 | 4 | (0.07%) |
| 3 | 3 | (0.05%) |
| 10 | 1 | (0.02%) |
| 11 | 1 | (0.02%) |
| 25 | 3 | (0.05%) |
| 28 | 8 | (0.14%) |
| 29 | 6 | (0.11%) |
| 31 | 1 | (0.02%) |
| 35 | 5,526 | (99.41%) |
| 36 | 6 | (0.11%) |

| | |
|---|---|
| . | . |
| . | . |

TABLE 5

| Status code | Count | |
|---|---|---|
| 2 | 8 | (0.09%) |
| 3 | 6 | (0.07%) |
| 7 | 2 | (0.01%) |
| 8 | 2 | (0.02%) |
| 9 | 2 | (0.02%) |
| 10 | 5 | (0.06%) |
| 11 | 1 | (0.01%) |
| 14 | 1 | (0.01%) |
| 24 | 4 | (0.05%) |
| 25 | 13 | (0.15%) |
| 26 | 33 | (0.39%) |
| 27 | 5,558 | (64.92%) |
| 29 | 1 | (0.01%) |
| 35 | 2,918 | (34.08%) |
| 36 | 7 | (0.08%) |

Therefore, among all the defaulted loans, some will likely move to the status code of 27 and default in the next month with a probability of 0.9941, while some will likely move to the status code of 26 and default in the next month with a probability of 0.3408.

The system may select three groups of defaulted cases:
defaulted group 1: defaulted observations for training from the status code of 27 on the previous month,
defaulted group 2: defaulted observations for training from the status code of 26 on the previous month,
defaulted group 3: defaulted observations for training from the status codes other than 27 and 26.

As Table 4 and Table 5 show, those three groups may have different payment behaviors, resulting in three different payer types. Thus, three separate probability models may represent each type well. With this reasoning, the system may analyze the loan data to develop (i.e., “train”) three defaulted HMMs: defaulted HMM1 (trained with the defaulted group 1), defaulted HMM2 (trained with the defaulted group 2), and defaulted HMM3 (trained with the defaulted group 3). The BIC analysis for the defaulted HMM1 is shown below in Table 6, and the optimal number of hidden states is 10. The BIC analysis for the defaulted HMM2 is shown below in Table 7, and the optimal number of hidden states is 9. The BIC analysis for the defaulted HMM3 is shown below in Table 8, and the optimal number of hidden states is 11.

TABLE 6

| | # of | | −Log- | |
|---|---|---|---|---|
| Default | parameters | | likelihood | |
| 1 (N) | (d_{N}) | penalty | (−ln L) | BIC_{N} |
| 3 states | 116 | 499.80 | 87,556.71 | 88,056.51 |
| 4 states | 159 | 685.07 | 73,936.44 | 74,621.50 |
| 5 states | 204 | 878.96 | 61,362.96 | 62,241.92 |
| 6 states | 251 | 1,081.46 | 50,972.34 | 52,053.81 |
| 7 states | 300 | 1,292.58 | 42,751.22 | 44,043.80 |
| 8 states | 351 | 1,512.32 | 36,640.08 | 38,152.40 |
| 9 states | 404 | 1,740.68 | 50,945.84 | 52,686.52 |
| 10 states | 459 | 1,977.65 | 35,902.26 | 37,879.92 |
| 11 states | 516 | 2,223.24 | 35,813.38 | 38,036.62 |
| 12 states | 575 | 2,477.45 | 35,884.16 | 38,361.61 |

TABLE 7

| | # of | | −Log- | |
|---|---|---|---|---|
| Default | parameters | | likelihood | |
| 2 (N) | (d_{N}) | penalty | (−ln L) | BIC_{N} |
| 3 states | 116 | 462.76 | 37,755.21 | 38,217.97 |
| 4 states | 159 | 634.30 | 32,164.58 | 32,798.88 |
| 5 states | 204 | 813.82 | 27,255.45 | 28,069.28 |
| 6 states | 251 | 1,001.32 | 23,944.56 | 24,945.89 |
| 7 states | 300 | 1,196.80 | 21,049.14 | 22,245.93 |
| 8 states | 351 | 1,400.25 | 18,291.85 | 19,692.10 |
| 9 states | 404 | 1,611.69 | 16,861.72 | 18,473.40 |
| 10 states | 459 | 2,088.65 | 18,566.25 | 20,397.35 |
| 11 states | 516 | 2,348.02 | 17,016.21 | 19,074.70 |
| 12 states | 575 | 2,616.50 | 17,013.85 | 19,307.71 |

TABLE 8

| | # of | | −Log- | |
|---|---|---|---|---|
| Default | parameters | | likelihood | |
| 3 (N) | (d_{N}) | penalty | (−ln L) | BIC_{N} |
| 3 states | 116 | 527.85 | 9,353.11 | 9,715.73 |
| 4 states | 159 | 723.52 | 8,704.88 | 9,201.91 |
| 5 states | 204 | 928.29 | 8,331.20 | 8,968.89 |
| 6 states | 251 | 1,142.16 | 7,996.62 | 8,781.24 |
| 7 states | 300 | 1,365.13 | 7,837.36 | 8,775.15 |
| 8 states | 351 | 1,597.20 | 7,337.49 | 8,434.70 |
| 9 states | 404 | 1,838.37 | 7,331.84 | 8,594.72 |
| 10 states | 459 | 2,088.65 | 6,908.83 | 8,343.65 |
| 11 states | 516 | 2,348.02 | 6,715.21 | 8,328.21 |
| 12 states | 575 | 2,616.50 | 6,954.91 | 8,752.33 |

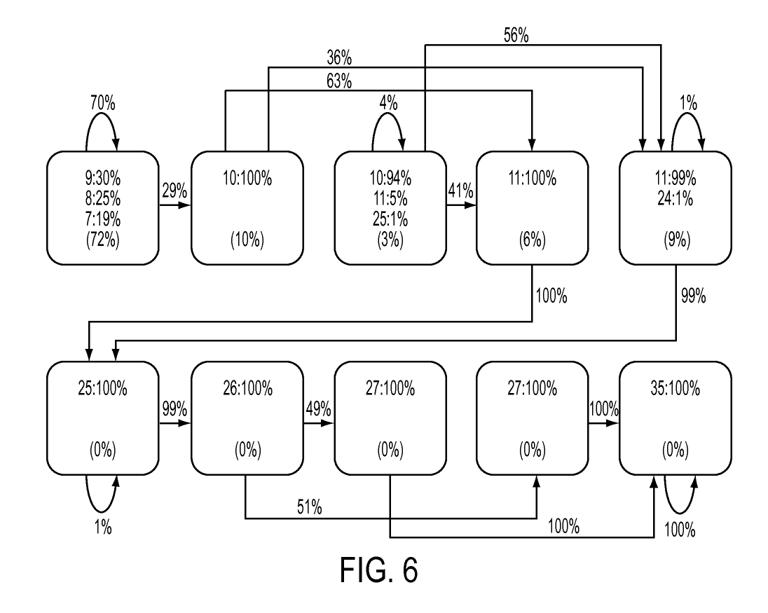

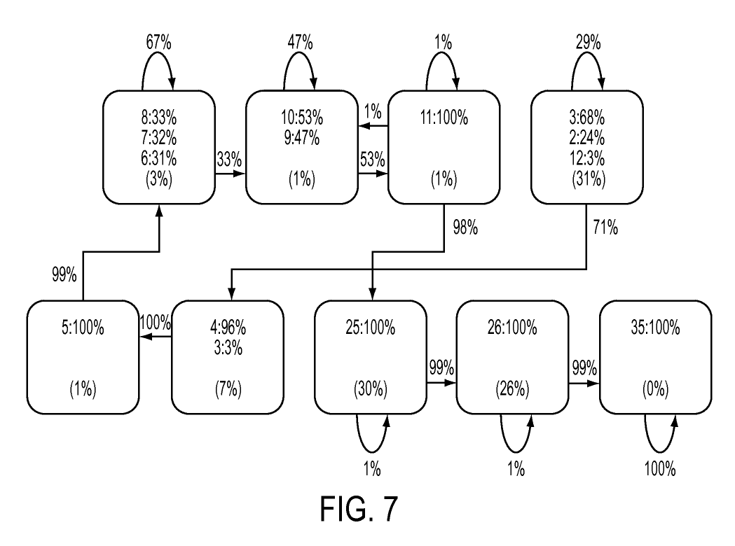

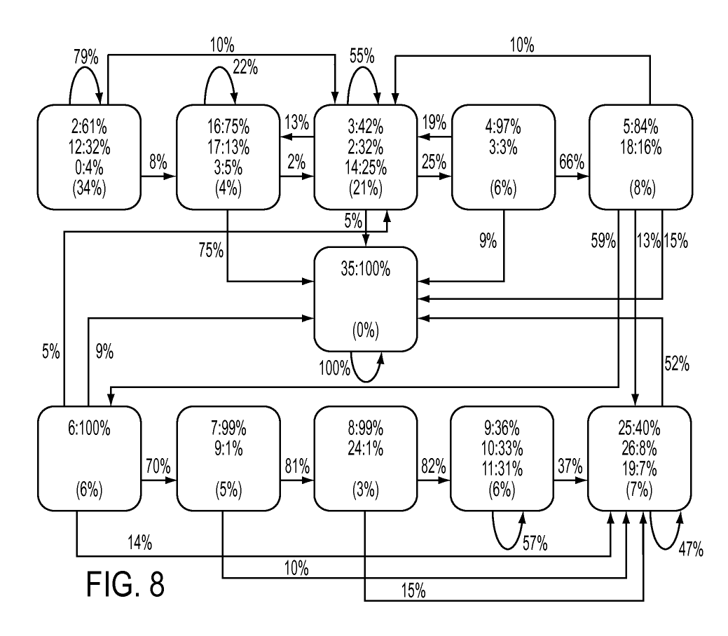

The system may apply the Baum-Welch algorithm to the data to estimate the parameters of all three defaulted HMMs. FIG. 6 depicts the trained result is depicted for the 10-state defaulted HMM1. FIG. 7 depicts the trained model for the 9-state defaulted HMM2, and FIG. 8 depicts the trained model for the 11-state defaulted HMM3. Note that if a loan is classified for the defaulted HMM1, loans having status code 27 exhibit almost a 100% probability of moving to a default state. If a loan is classified for the defaulted HMM2, a loan having status code 26 is almost 99% likely to default within the next month. If a loan is classified to the defaulted HMM3, it may default on other status codes in addition to status codes 26 and 27.

In some embodiments, the data in the loan data set may be segmented or clustered into groups, so that various models reflect not only loan states but other factors such as geographic location of the borrowers, demographics of the borrowers, or other economic, financial or social-political conditions. For example, models may be developed for individual sub-populations considering one or more attributes of the sub-population such as geography of the borrower (e.g., state, city, county, etc.), age of the borrower, type of loan (e.g., government program or private), lender name, or other attributes. The system may then consider the attributes when classifying an active loan to a model by selecting a loan model having one or more of the attributes of a loan. For example, a loan issued to a borrower in the state of Delaware may be classified to a loan model that is developed based on loan data for borrowers in Delaware. The clustering may be performed using any now or hereafter known clustering method, such k-means clustering (i.e., an unsupervised clustering technique) or a supervised clustering technique.

Naïve Method:

In a naïve method, the system may simply classify a new active loan to a model, observe the loan's status within the model, and send an alert when the loan is in a particular status, such as a status of n months' delinquency.

### Loan Classification and Default Prediction

To predict the likelihood of default of an active loan, as noted above the system will first classify the loan in question to one of the available models. It may then determine a probability of default in the near future (e.g., an upcoming time period such as one months, three months, or another period) using parameters of the model to which the target loan is classified. Depending on the method by which the loan data is monitored, the classification and prediction may be done in various ways, including those described below. In the methods described below, the following variables are used:
T: the current time,
sₜ: status code at time t,
S_{T}: the history of loan status up to time T, S_{T}=(s₁, s₂, . . . , s_{T})

Simple HMM

To classify the loan, in the simple HMM framework the system has two different models: the paid HMM and the defaulted HMM. The system uses a Bayesian analysis to classify a loan in accordance with a model. This includes determining a probability that the loan will be in paid HMM and determining a probability that the loan will be in defaulted HMM, in each case when the history of the loan S_{T}. Those two probabilities are posterior (historic) probabilities in the Bayesian framework. The posterior probability of the paid HMM is

$$Pr ( paid HMM \vert {S}_{T} ) = \frac{Pr ( {S}_{T} \vert paid HMM ) Pr ( paid HMM )}{Pr ( {S}_{T} )} .$$

The posterior probability of the defaulted HMM is

$$Pr ( defaulted HMM \vert {S}_{T} ) = \frac{Pr ( {S}_{T} \vert defaulted HMM ) Pr ( defaulted HMM )}{Pr ( {S}_{T} )} .$$

The system compares the two posterior probabilities and classifies the loan to the probability model having a higher posterior probability. The two probabilities share a common denominator, so it is enough to compare the numerators of the two posterior probabilities. Pr(S_{T}|paid HMM) is the likelihood of S_{T} when the probability model is the paid HMM, and Pr(paid HMM) is the prior probability of the paid HMM. In the same way, Pr(S_{T}|defaulted HMM) is the likelihood of S_{T} when the probability model is the defaulted HMM, and Pr(defaulted HMM) is the prior probability of the defaulted HMM. In some embodiments, the prior probabilities may be assumed to be proportional to the initial population of the training sets. For example, if the loan set used to train the paid model included 13,771 loans and the loan set used to train the defaulted model included 8,963 loans, the prior probability of the paid HMM would be (13,771/(13,771+8,963))=0.6057, and the prior probability of the defaulted HMM is (8,963/(13,771+8,963))=0.3943.

Once the target loan has been classified to a model, the system determines a default probability during a prospective time period—such as the next payment period. The system observes the history of S_{T} and sends an alert, such as a signal to the loan department that the loan is in the danger of defaulting at the next payment period, if the probability exceeds a threshold. The threshold may be 50%, 60%, 75%, 80%, or another value. The system uses the estimated parameters of the probability model to which the loan is classified to calculate the default probability. If the sequence is classified into the paid HMM, the probability of defaulting is zero because the sequence is predicted as paid off at the time of observation. However, if the loan is classified into the defaulted HMM, then the system will estimate the probability of defaulting using the estimated parameters of the defaulted HMM. Note that the loan is defaulted when its hidden state is 8 in the simple HMM case examples described above.

$$Pr ( {q}_{T + 1} = 8 \vert {S}_{T} ) = {\sum }_{i = 1}^{8} Pr ( {q}_{T} = i \vert {S}_{T} ) {a}_{i 8} .$$

Pr(q_{T}=i|S_{T}) can be computed by the forward algorithm (refer to [2]) and aᵢⱼ is the state transition probability of defaulted HMM.

If an earlier prediction is desired, then the system can calculate the probability of going into the state 8 (default state) at time T+h as follows:

$$Pr ( {q}_{T + h} = 8 \vert {S}_{T} ) = {\sum }_{i = 1}^{8} Pr ( {q}_{T} = i \vert {S}_{T} ) {a}_{i 8}^{( h )} .$$

where aᵢⱼ^{(h)} is the (i, j) element of the transition matrix multiplied by itself h times.

Segmented HMM

If the system built its models using the segmented HMM method, the system will have at least four different probability models. In the example shown above and in FIGS. 6-8, there are three defaulted HMMs and one paid HMM. The target loan may be classified to one of the probability models using a Bayesian analysis as described above, such that the loan is classified to the having greatest posterior probability. In this method, the posterior probability of the paid HMM is

$$Pr ( paid HMM \vert {S}_{T} ) = \frac{Pr ( {S}_{T} \vert paid HMM ) Pr ( paid HMM )}{Pr ( {S}_{T} )} .$$

The posterior probability of the defaulted HMM1 is

$$Pr ( defaulted HMM 1 \vert {S}_{T} ) = \frac{Pr ( {S}_{T} \vert defaulted HMM 1 ) Pr ( defaulted HMM 1 )}{Pr ( {S}_{T} )} .$$

The posterior probability of the defaulted HMM2 is

$$Pr ( defaulted HMM 2 \vert {S}_{T} ) = \frac{Pr ( {S}_{T} \vert defaulted HMM 2 ) Pr ( defaulted HMM 2 )}{Pr ( {S}_{T} )} .$$

The posterior probability of the defaulted HMM3 is

$$Pr ( defaulted HMM 3 \vert {S}_{T} ) = \frac{Pr ( {S}_{T} \vert defaulted HMM 3 ) Pr ( defaulted HMM 3 )}{Pr ( {S}_{T} )} .$$

The system compares the four posterior probabilities and classifies the loan to the probability model having the highest posterior probability. The four probabilities share the same denominator, so it is enough to compare the numerators of the four posterior probabilities. Pr(S_{T}|paid HMM) is the likelihood of S_{T} when the probability model is the paid HMM. In the same way, Pr(S_{T}|defaulted HMM i) is the likelihood of S_{T} when the probability model is the defaulted HMM i, for i=1, 2, 3. Pr(Defaulted HMM) is the prior probability of the paid HMM. The prior probabilities (Pr(paid HMM), Pr(defaulted HMM 1), Pr(defaulted HMM 2), Pr(defaulted HMM 3)) may be assumed to be proportional to the initial population of the training sets. As an example, if the loan set used to train the paid model included 13,771 loans, the loan set of the defaulted observations of type 1 in the training set is 5,526, the loan set of the defaulted observations of type 2 in the training set is 2,918, and the loan set of the defaulted observations of type 3 is 519, then the prior probabilities are as follows:
Prior probability of the paid HMM: (13,771/(13,771+5,526+2,918+519))=0.6057.
Prior probability of the defaulted HMM 1: (5,526/(13,771+5,526+2,918+519))=0.2431.
Prior probability of the defaulted HMM 2: (2,918/(13,771+5,526+2,918+519+8,963))=0.1284.
Prior probability of the defaulted HMM 3: (519/(13,771+5,526+2,918+519))=0.0228.

The system may calculate probabilities for different time periods if desired. In such a situation, if the loan is classified into the paid HMM, the probability of defaulting would be zero. However, if the loan is classified into one of the defaulted HMMs, then the system can determine the probability using an equation such as that described above under the simple HMM discussion.

As described above, if the probability of defaulting in a certain time period (such as n months ahead) is greater than a predetermined threshold, then a message may be a loan service department or other user. The threshold may be selected in one of any number of ways, such as manual input, or automatic determination. One method of automatically determining a threshold may consider two “error” scenarios: false positive and false negative. This system would yield a false positive if it were to send an alert even though the loan does not default during the prospective period of interest. In other hand, the false negative would fail to provide an alert about a loan that actually defaults during the period of interest. Optionally, the system may vary the threshold used for each loan based on the loan's model classification.

For example, the system may determine a measure of precision and a measure of recall for each model. Precision is defined as:

$$precision = \frac{true positive}{true positive + false positive}$$

Recall is defined as:

$$recall = \frac{true positive}{true positive + false negative}$$

The system may use or reserve some paid observations and defaulted observations for the purpose of testing. For example, there may be 1,531 paid observations and 996 defaulted observations used to determine precision and recall. For all the loans in the testing group, the system calculates past probability of defaulting uses methods such as those described above, and then it determines whether each loan actually defaulted within a certain time after the probability period.

Based on the accurate positive determinations and the false positive determinations, the system may calculate precision and recall as defined as above. Table 9 below follows the prior examples and observes that the precision is 0.9909 and recall is 0.6586 using the naïve method generating a default signal whenever a loan is in the status code of 27. Even though its precision is very high, its recall rate is very low, which reflects that 99.41% of the loans whose status code is 27 will defaulting in the next month as shown in Table 4 above. However, it misses the loans which will default in the next month when the status code is 26. When the system generates an alert whenever a loan is in state 26 or 27, its precision is 0.5818 and its recall is 0.9458. If the status code of 26 for the default signal, the recall rate improves at the expense of lower precision, which reflects that only 34% loans in the status code of 26 will be defaulting in the next month as shown in Table 5 above. Table 10 shows precision and recall for a simple HMM method in various threshold levels. Table 11 shows precision and recall for a segmented HMM method in various threshold levels.

The precision can be improved as the threshold level increases, but at the expense of the decreased recall. Using these two measures and weighting them by importance, the system can determine an optimal level of threshold. For example, if one assumes that importance weights are a₁ and a₂, possible thresholds can be determined as a1*precision+a2*recall at each level of threshold. The system can then compare the determined thresholds to find the optimal one.

TABLE 9

| Status | True | False | Total | | |
|---|---|---|---|---|---|
| code | positive | positive | defaults | Precision | Recall |
| (27) | 656 | 6 | 996 | 0.9909 | 0.6586 |
| (26, 27) | 942 | 677 | 996 | 0.5818 | 0.9458 |

TABLE 10

| | True | False | Total | | |
|---|---|---|---|---|---|
| Threshold | positive | positive | defaults | Precision | Recall |
| 0.1 | 944 | 700 | 996 | 0.5742 | 0.9478 |
| 0.2 | 944 | 699 | 996 | 0.5746 | 0.9478 |
| 0.3 | 944 | 696 | 996 | 0.5756 | 0.9478 |
| 0.4 | 944 | 695 | 996 | 0.5760 | 0.9478 |
| 0.5 | 944 | 691 | 996 | 0.5774 | 0.9478 |
| 0.6 | 0 | 0 | 996 | . | . |

TABLE 11

| | True | False | Total | | |
|---|---|---|---|---|---|
| Threshold | positive | positive | defaults | Precision | Recall |
| 0.1 | 955 | 216 | 996 | 0.8155 | 0.9588 |
| 0.2 | 953 | 187 | 996 | 0.8360 | 0.9568 |
| 0.3 | 953 | 183 | 996 | 0.8389 | 0.9568 |
| 0.4 | 953 | 183 | 996 | 0.8389 | 0.9568 |
| 0.5 | 953 | 183 | 996 | 0.8389 | 0.9568 |
| 0.6 | 942 | 142 | 996 | 0.8690 | 0.9458 |
| 0.7 | 942 | 138 | 996 | 0.8722 | 0.9458 |
| 0.8 | 929 | 95 | 996 | 0.9072 | 0.9327 |
| 0.9 | 929 | 95 | 996 | 0.9072 | 0.9327 |

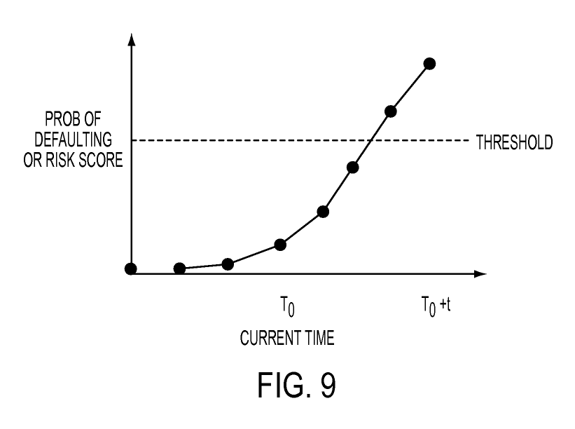

In practice, the system may operate according to a method where a user of the system selects a prospective time period of interest (t), such as 1 month, 2 months, or 3 months. The system may send this time period value to the prediction system to use a t-month model to classify all active loans according to an appropriate model and determine the probability of whether each active loan will default during the period t. The system may return a report to the user showing information (such an account number, identification code, or borrower name) for all loans whose risk of default exceeds a threshold probability during the time period t. Optionally, if the report is provided via an interactive display (such as a computer monitor with input devices), the user can select one of the loans to receive a report of the borrower's historic payment data. This data can be shown in text format, or a graphic format such as that shown in FIG. 9.

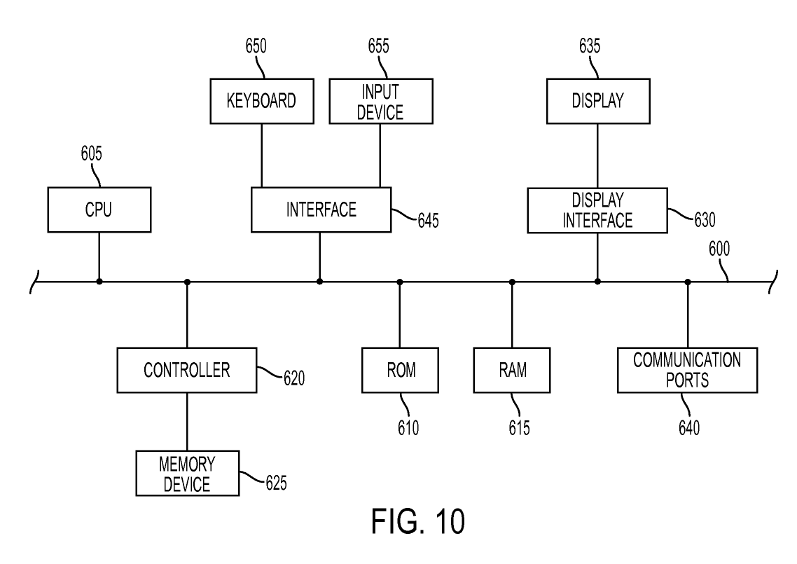

FIG. 10 depicts a block diagram of exemplary internal hardware that may be used to contain or implement the various services and processing devices as discussed above. A bus 600 serves as the main information highway interconnecting the other illustrated components of the hardware. CPU 605 is the central processing unit of the system, performing calculations and logic operations required to execute a program. CPU 605, alone or in conjunction with one or more of the other elements disclosed in FIG. 10 is an exemplary processing device, computing device or processor as such terms are used within this disclosure. Read only memory (ROM) 610 and random access memory (RAM) 615 constitute exemplary memory devices.

A controller 620 provides an interface between with one or more optional tangible, computer-readable memory devices 625 and the system bus 600. These memory devices 625 may include, for example, an external or internal DVD drive, a CD ROM drive, a hard drive, flash memory, a USB drive or the like. As indicated previously, these various drives and controllers are optional devices. Additionally, the memory devices 625 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing any the methods and systems as discussed above may be stored in the ROM 610 and/or the RAM 615. Optionally, the program instructions may be stored on a tangible computer readable medium such as a compact disk, a digital disk, flash memory, a memory card, a USB drive, an optical disc storage medium, such as a Blu-Ray™ disc, and/or other recording medium. As used in this document, the phrase “computer-readable storage medium” is intended to include any such computer-readable device or tangible structure (such as 610, 615 or 625). In addition, when this document refers to computer-readable storage media as a “first” computer-readable storage medium, “second” computer-readable storage medium, etc., the reference encompasses both separate structures as well as a single structure having multiple storage locations within the structure.

An optional display interface 630 may permit information from the bus 600 to be displayed on the display 635 in audio, visual, graphic or alphanumeric format. The information may include information related to a current job ticket and associated tasks. Communication with external devices may occur using various communication ports 640. An exemplary communication port 640 may be attached to a communications network, such as the Internet or an local area network.

The hardware may also include an interface 645 which allows for receipt of data from input devices such as a keyboard 650 or other input device 655 such as a mouse, a joystick, a touch screen, a remote control, a pointing device, a video input device and/or an audio input device.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A loan monitoring system, comprising:
a processor; and
a computer-readable storage medium that holds programming instructions that instruct the processor to:
receive a loan data set, the loan data set comprising first data relating to a plurality of loans that are in a default status and second data relating to a plurality of loans that are in a non-default status,
develop, based on the first data and the second data, a set of loan models, wherein the loan models comprise at least one defaulted loan model and at least one non-defaulted loan model,
receive data relating to a target loan,
based on the data relating to the target loan, classify the target loan in accordance with one of the loan models, and
based on the loan model to which the target loan is classified, determine a probability of default over a prospective time period for the target loan.

2. The system of claim 1, wherein the instructions also instruct the processor to:
deliver a message to a loan service provider, the message comprising the probability of default or a report reflecting the probability of default.

3. The system of claim 1, wherein the instructions also instruct the processor to:
determine whether the probability of default exceeds a threshold; and
in response to determining that the probability of default exceeds the threshold, deliver an alarm message to a loan service provider, the alarm message comprising the probability of default.

4. The system of claim 1, wherein the instructions that instruct the processor to develop the set of loan models comprise instructions to:
select a number of loan models for the set of loan models;
train each of the loan models by:
analyzing, for each loan in the loan data set, observed data over a historic time period,
determining a number of hidden states for the model, wherein the number of hidden states is that which minimizes a Bayesian information criterion, and
for at least one hidden state in the model, establishing a probability that any loan in the loan data set will move from that state to another hidden state in the model during the historic time period.

5. The system of claim 1, wherein the instructions that instruct the processor to classify the target loan in accordance with one of the loan models comprise instructions to:
for each loan model in the set of loan models, determine a posterior probability that the target loan would have corresponded to the loan model during a historic time period; and
classify the target loan in accordance with the loan model having the highest determined probability.

6. The system of claim 5, wherein the instructions that instruct the processor to determine a probability of default within a prospective time period for the target loan comprise instructions to:
for the loan model to which the target loan is classified:
identify the hidden state that represents a state of default; and
establish a probability that the target loan will be in the state of default in a prospective time period, and
select the established probability as the probability of default.

7. The system of claim 1, wherein:
the instructions for developing a set of loan models also comprise instructions to:
receive one or more attributes for a loan population, and
develop a set of loan models for a loan population having at least one common attribute; and
the instructions for classifying a target loan to a loan model comprise instructions to:
determine an identified attribute for the target loan, and
classify the target loan to a loan model having the same attribute as the target loan's identified attribute.

8. A computer-implemented method of monitoring a loan for potential default, comprising:
receiving a loan data set, the loan data set comprising first data relating to a plurality of loans that are in a default status and second data relating to a plurality of loans that are in a non-default status;
developing, based on the first data and the second data, a set of loan models, wherein the loan models comprise at least one defaulted loan model and at least one non-defaulted loan model;
receiving data relating to a target loan;
by a processor based on the data relating to the current loan, classifying the target loan in accordance with one of the loan models; and
by the processor based on the loan model to which the target loan is classified, determining a probability of default over a prospective time period for the target loan.

9. The method of claim 8, further comprising:
assessing, by the processor, whether the probability of default exceeds a threshold; and
by the processor in response to assessing that the probability of default exceeds the threshold, delivering an alarm message to a loan service provider, the alarm message comprising the probability of default.

10. The method of claim 8, wherein developing the set of loan models comprises:
selecting a number of loan models for the set of loan models;
training each of the loan models by:
analyzing, for each loan in the loan data set, observed data over a historic time period,
determining a number of hidden states for the model, wherein the number of hidden states is that which minimizes a Bayesian information criterion, and
for at least one hidden state in the model, establishing a probability that any loan in the loan data set will move from that state to another hidden state in the model during the historic time period.

11. The method of claim 8, wherein classifying the target loan in accordance with one of the loan models comprises:
for each loan model in the set of loan models, determining a posterior probability that the target loan would have corresponded to the loan model during a historic time period; and
classifying the target loan in accordance with the loan model having the highest determined posterior probability.

12. The method of claim 11, wherein determining a probability of default within a prospective time period for the target loan comprises:
by the processor for the loan model to which the target loan is classified:
identifying the hidden state that represents a state of default; and
establishing a probability that the target loan will be in a state of default during a prospective time period, and
selecting the established probability as the probability of default.

13. The method of claim 8, wherein each model in the set of loan models comprises a Hidden Markov Model, a Kalman filter model, or a finite state machine.

14. The method of claim 10, wherein, for each loan model, the hidden states comprise at least:
a first state in which a majority of loans are paid off;
a second state in which a majority of loans are current;
a third state in which a majority of loans are delinquent; and
a fourth state in which a majority of loans are in default, forbearance, deferment or subject to a claim.

15. A computer-implemented method of identifying a loan that is likely to default, comprising having a processor implement instructions to:
access a set of loan models in a computer-readable storage medium, wherein the loan models comprise at least one defaulted loan model and at least one non-defaulted loan model, and each loan model;
receive data relating to a target loan;
based on the data relating to the current loan, automatically classify the target loan in accordance with one of the loan models by:
for each loan model in the set of loan models, determining a posterior probability that the target loan would have corresponded to the loan model during a historic time period, and
classifying the target loan in accordance with the loan model having the highest determined posterior probability;
based on the loan model to which the target loan is classified, automatically determine a probability of default over a prospective time period for the target loan by, for the loan model to which the target loan is classified:
identifying a hidden state that represents a state of default,
establishing a probability that the target loan will be in a state of default during a prospective time period, and
selecting the established probability as the probability of default;
assess whether the probability of default exceeds a threshold; and
in response to assessing that the probability of default exceeds the threshold, generate a report relating to the probability of default.

16. The method of claim 15, further comprising, before the processor receives the data relating to a target loan, causing the processor to implement instructions to:
select a number of loan models for the set of loan models;
train each of the loan models by:
analyzing, for each loan in the loan data set, observed data over a historic time period,
determining a number of hidden states for the model, wherein the number of hidden states is that which minimizes a Bayesian information criterion, and
for at least one hidden state in the model, establishing a probability that any loan in the loan data set will move from that state to another hidden state in the model during the historic time period.

17. The method of claim 15, wherein each model in the set of loan models comprises a Hidden Markov Model, a Kalman filter model, or a finite state machine.

18. The method of claim 16, wherein, for each loan model, the hidden states comprise at least:
a first state in which a majority of loans are paid off;
a second state in which a majority of loans are current;
a third state in which a majority of loans are delinquent; and
a fourth state in which a majority of loans are in default, forbearance, deferment or subject to a claim.

19. The method of claim 15, wherein:
developing the set of loan models also comprises:
receiving one or more attributes for a loan population, and
developing a set of loan models for a loan population having at least one common attribute; and
classifying a target loan to a loan model comprises:
determining an identified attribute for the target loan, and
classifying the target loan to a loan model having the same attribute as the target loan's identified attribute.
